(19) United States
(12) Patent Application Publication
(10) Pub. No.: US 2006/0186359 A1
(43) Pub. Date: Aug. 24, 2006

(54) Electronic apparatus

(76) Inventor: Hajime Suzukawa, Hino-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/359,234

(22) Filed: Feb. 21, 2006

(30) Foreign Application Priority Data
Feb. 24, 2005 (JP) 2005-049345

(51) Int. Cl. G02B 27/00

(52) U.S. Cl. 250/551

(57) ABSTRACT

According to one embodiment, an electronic apparatus includes a housing having a surface, a first capacitance switch positioned in a first region of the surface, a first light-emitting element configure to emit light when the first capacitance switch operated, and a first light-transmitting portion positioned in a second region of the surface and transmits the light from the first light-emitting element.

### CROSS-REFERENCE TO RELATED APPLICATIONS

This application is based upon and claims the benefit of priority from Japanese Patent Application No. 2005-49345, filed Feb. 24, 2005, the entire contents of which are incorporated herein by reference.

### BACKGROUND

1. Field

One embodiment of the invention relates to an electronic apparatus, for example, having a capacitance switch.

2. Description of the Related Art

Generally, capacitance switches are widely used as input means for various purposes. The capacitance switches are configured to detect change in capacitance when the human body touches to them, and output a signal.

Capacitance switches provide no tactile response, unlike push-button switches, and users cannot know whether the switches detect touching when they touch the switches by finger. Therefore, there is a technique to notify the user of detection of the user's touch of switches, by lighting up light-emitting elements provided below the respective switches (see U.S. Pat. No. 6,664,489 (FIG. 3 and 9)).

This document discloses providing LED (light emitting diode) below sensor surfaces of touch switches, and light emitted from the LED is transmitted through the sensor surfaces.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view illustrating a schematic structure of a personal computer according to an embodiment of the present invention;

FIG. 2 is an exemplary plan view illustrating details of AV switches according to the embodiment of the present invention;

FIG. 3 is an exemplary diagram illustrating a state where a switch according to the embodiment of the present invention is touched;

FIG. 4 is an exemplary cross-sectional view illustrating a structure of switches and light-transmitting portions according to the embodiment of the present invention;

FIG. 5 is an exemplary exploded perspective view of the switches and the light-transmitting portions according to the embodiment of the present invention;

FIG. 6 is an exemplary block diagram illustrating a circuit configuration of the personal computer according to the embodiment of the present invention; and

FIG. 7 is an exemplary cross-sectional view illustrating a modification of the structure of the switches and the light-transmitting portions.

### DETAILED DESCRIPTION

Various embodiments according to the invention will be described hereinafter with reference to the accompanying drawings. In general, according to one embodiment of the invention, an electronic apparatus comprising: a housing having a surface; a first capacitance switch which is positioned in a first region of the surface; a first light-emitting element which emits light if the first capacitance switch is operated; and a first light-transmitting portion which is positioned in a second region of the surface and transmits the light from the first light-emitting element.

FIG. 1 is a diagram illustrating a structure of a notebook personal computer serving as an information processing apparatus according to a first embodiment of the present invention.

The personal computer comprises a computer main body 12, and a display unit (display section) 14. In a housing of the display unit 14, mounted are an LCD (Liquid Crystal Display) 16 being a display panel, a backlight (not shown) being a light source, and an inverter 17 to drive the backlight. The display unit 14 is attached to hinges (support portions) 18 provided on a back end portion of the computer main body 12, such that the display unit 14 is rotatable between an open position, in which the display unit 14 covers an upper surface of the computer main body 12, and a closed position, in which the upper surface of the computer main body 12 is exposed.

The computer main body 12 has a thin box-shaped housing, and a keyboard 20 is provided in a central portion of an upper surface of the housing. A palm rest is provided in a front portion of the upper surface of the housing of the computer main body 12. A touch pad 22, a scroll button 24 and touch pad control buttons 26 are provided in an almost central portion of the palm rest. On a back portion of the upper surface of the hosing of the computer main body 12, arranged are a power button 28 to turn on/off the power of the computer main body 12, AV switches 30 including ten switches, and a right and a left speakers S_{R} and S_{L}. On an upper surface of the housing, provided are indicators (LED) 36 that indicate the power state and the operation state of the HDD and the like, and a remote control receiving section 38.

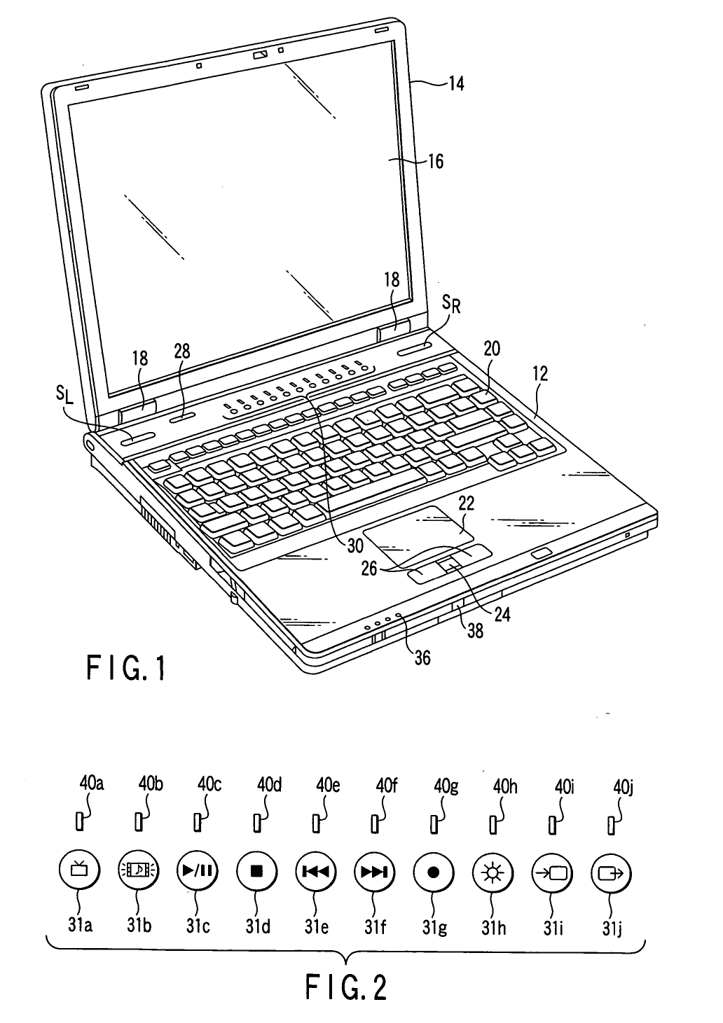

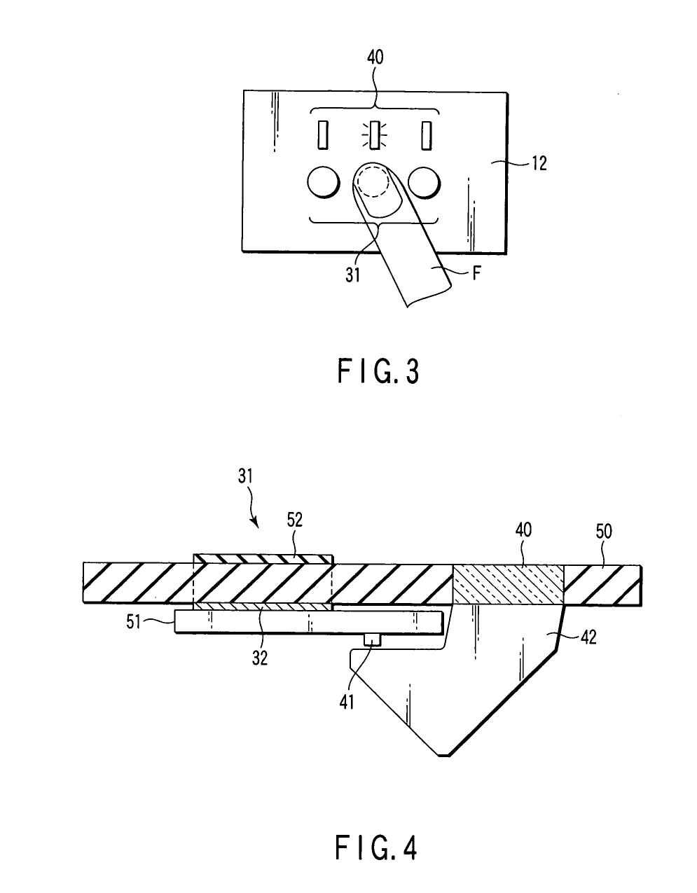

FIG. 2 is a diagram illustrating details of the AV switches 30 including ten switches. A TV switch 31a, a CD/DVD switch 31b, a play/pause switch 31c, a stop switch 31d, a reverse switch 31e, a forward switch 31f, a record switch 31g, a brightness switch 31f, a monitor input switch 31i, and a TV output switch 31j are arranged from the left in this order. Light-transmitting portions 40a to 40j corresponding to the respective switches 31a to 31j are provided above the respective switches 31a to 31j (between the switches 31a to 31j and the hinges 18). The light-transmitting portions 40a to 40j are provided outside outer peripheries of the switches 31a to 31j. As shown in FIG. 3, when the user touches a surface of one switch 31, an LED corresponding to the touched switch 31 and provided inside the computer main body 12 is turned on, and light of the LED is transmitted through the corresponding light-transmitting portion 40.

Each of the switches 31a to 31j is a capacitance switch that detects change in capacitance and detects operation thereof. Then, data corresponding to the operated switch (one of 31a to 31j) is input in an embedded controller/keyboard controller IC, which is described below, provided in the computer main body 12. Then, in response to the input data, the personal computer executes a predetermined operation.

The TV switch 31a is a touch switch to execute a TV viewing application to watch television programs. When the user touches a surface of the TV switch 31a by finger, the TV viewing application is started. The CD/DVD switch 31b is a touch switch to execute an AV viewing application to view a CD or a DVD.

When the user touches a surface of the CD/DVD switch 31b by finger, the AV viewing application is executed. When the play/pause switch 31c is touched, playback by the AV viewing application is started or paused. The stop switch 31d has a function of stopping playback.

When the user touches a surface of the reverse switch 31e by finger, return to a former track, chapter, or data is performed. When the forward switch 31f is touched, forwarding to a latter track, chapter, or data is performed. When the user touches a surface of the record switch 31g by finger, a record application is started and records a TV program on a hard disk drive provided in the computer main body 12 or a DVD medium mounted in an optical disk drive.

When the user touches a surface of the brightness switch 31h by finger, the brightness of the LCD panel 16 is changed. When the user touches a surface of the monitor input switch 31i, the image source to be displayed on the LCD 16 is switched from the internal image to an image input from the outside.

When the user touches a surface of the image output switch 31j by finger, image display is changed between the LCD panel 16 and the external output.

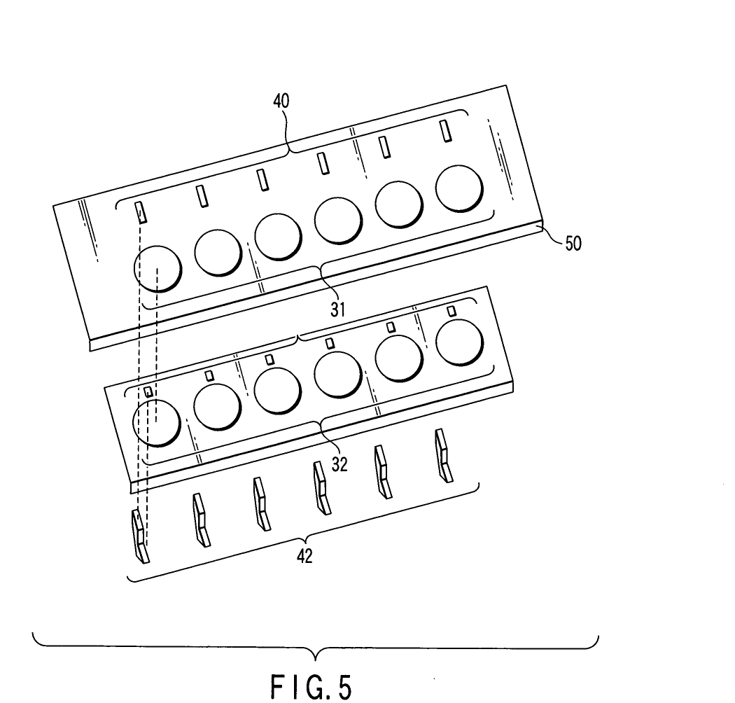

A structure of the switches and the light-transmitting portions are described with reference to FIGS. 4 and 5. As shown in FIG. 4, a switch 31 is formed in a first region of a surface of a panel 50. The panel 50 is a part of the housing of the computer main body 12, and formed of a dielectric. A light-transmitting portion 40 is disposed in a second region of the panel 50. The panel 50 is a transparent material, and colored in regions other than the light-transmitting portion 40 to prevent transmission of light. A coating 52 is applied on a surface of the panel 50 corresponding to the switch 31, such that the switch 31 can be easily viewed.

A printed circuit board 51 is arranged opposite an internal surface of the panel 50. An electrode 32 which forms a part of the switch 31 is provided on a surface of the printed circuit board 51 facing the panel 50. A capacitance detecting circuit is mounted on the printed circuit board 51. The capacitance detecting circuit detects change in capacitance when the human body approaches or touches an external surface of the switch 31 by using the electrode 32.

An LED (light emitting diode) 41 being a light-emitting element is mounted on an under surface of the printed circuit board 51. The LED 41 emits light in a direction from an upper surface to the under surface of the printed circuit board 51. The light emitted from the LED 41 is guided by an optical guide 42 and made incident on the light-transmitting portion 40. First, The light emitted from the LED 41 is made incident on the optical guide 42. The optical guide 42 rounds about and extends under the printed circuit board 51, and has a surface facing a light-emitting surface of the LED 41. Further, the optical guide 42 has a surface facing the light-transmitting portion 40. The light made incident on the optical guide 42 from the LED 41 is reflected inside the optical guide 42, and goes out of the surface facing the light-transmitting portion 40. The light which has gone out of the optical guide 42 is transmitted through the transparent light-transmitting portion 40, and the light-transmitting portion 40 looks to the user as if the light-transmitting portion 40 emits light.

Since the electrode 32 of the switch 31 and the LED 41 are provided on one printed circuit board, the manufacturing cost is reduced.

The LED 41 may be configured to emit light in a direction parallel to the substrate 50, that is, to the light-transmitting portion 40 side. However, in comparison with the case where the LED 41 emits light downward, the distance between the LED 41 and the light-transmitting portion 40 is short, and it is difficult to uniformly illuminate the light-transmitting portion 40 with the light transmitted through the optical guide 41. Therefore, to increase the difference between the LED 41 and the light-transmitting portion 40, the LED 41 is preferably configured to emit light in the direction from the upper surface to the under surface of printed circuit board 50.

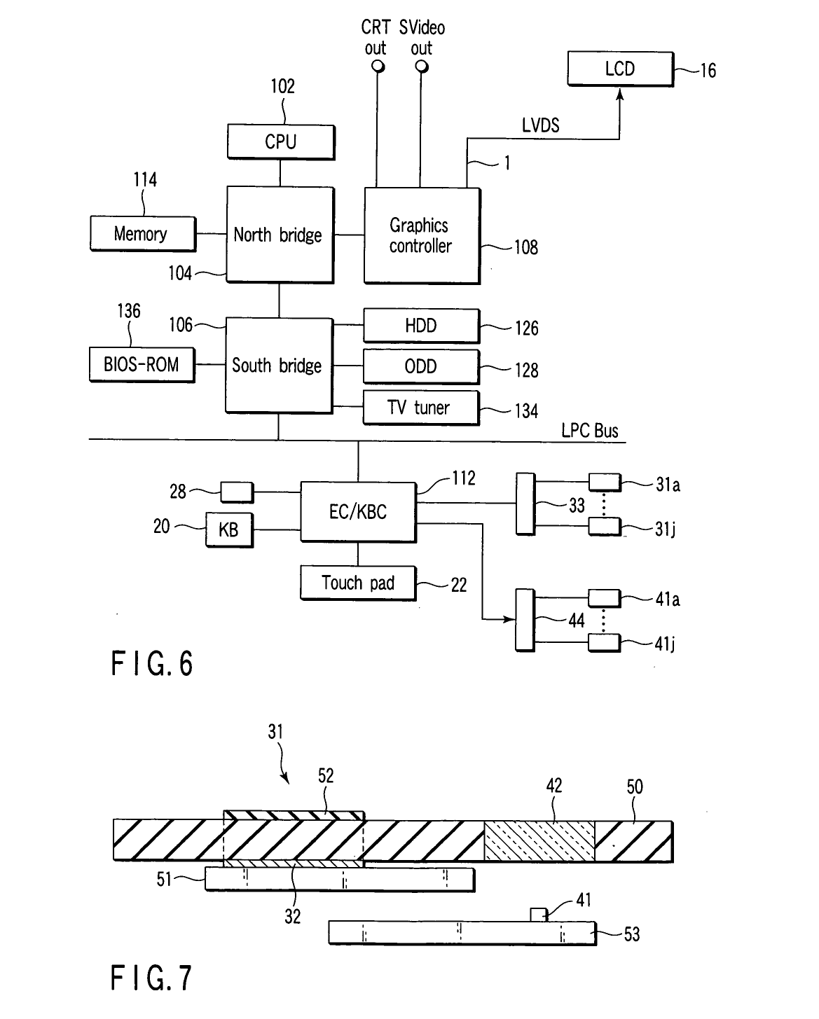

Next, a system configuration of the computer is described with reference to FIG. 6.

As shown in FIG. 6, the computer comprises a CPU 102, a north bridge 104, a main memory 114, a graphics controller 108, a south bridge 106, a BIOS-ROM 136, a hard disk drive (HDD) 126, an optical disk drive (ODD) 128, a TV tuner 134, and an embedded controller/keyboard controller IC (EC/KBC) 112, etc.

The CPU 102 is a processor provided to control operation of the computer. The CPU 102 executes an operating system (OS) and various application programs loaded from the hard disk drive (HDD) 126 to the main memory 114.

The CPU 102 also executes a BIOS (Basic Input Output System) stored in the BIOS-ROM 136. The BIOS is a program to control hardware.

The north bridge 104 is a bridge device which bridges a local bus of the CPU 102 and the south bridge 106. The north bridge 104 also includes a memory controller that controls access to the main memory 114. Further, the north bridge 104 has a function of performing communication with the graphic controller 108 through an AGP (Accelerated Graphics Port) bus or the like.

The graphics controller 108 is a display controller that controls the LCD 16 used as a display monitor of the computer. The graphics controller 108 has a video memory (VRAM) and generates, from display data stored in the video memory by the OS or application programs, an image signal that forms a display image to be displayed on the LCD 16.

An image signal generated by the graphic controller 108 is output to a line 1. The graphics controller 108 also has an interface to output an analogue image signal to an external CRT (Cathode Ray Tube), and an interface to output an analogue image signal to the outside through an S video terminal.

When one of the switches 31a to 31j is operated, the corresponding switch, which is one of 31a to 31j, outputs an event signal to a switch controller 33. The switch controller 33 notifies, by a 16-bit serial signal, the embedded controller/keyboard controller IC (EC/KBC) 112 which switch has outputted the event signal. In the 16-bit serial signal, a bit corresponding to a switch that has output an event signal is set to “Hi”. Thereby, on the basis of the 16-bit serial signal, it is possible to determine which switch has outputted the event signal.

When any of the switches 31a to 31j is operated, the embedded controller/keyboard controller IC 112 recognizes the operated switch. The embedded controller/keyboard controller IC 112 instructs an LED controller 44 to cause the LED (one of 41a to 41j) corresponding to the recognized switch to emit light. Then, the LED corresponding to the operated switch emits light, and light is transmitted through the corresponding light-transmitting portion 40. The LED 41 may be configured to emit light in ways different from one another, according to function assigned to the switches 31a to 31j. Information indicating light-emitting operations of the LED 41 is registered on the BIOS-ROM 136, for example. The information indicating light-emitting operations may be configured to be changeable by a utility operating on the OS or a BIOS image. The user can recognize light transmitted through the light-transmitting portion 40 more easily, by changing the light-emitting operations of the LED 41 according to preferences of the user.

The LED 41 may be kept turned on only while the corresponding switches 31 are operated, or may be kept turned on for a predetermined time after operation of the switches 31 is detected. In the case where the LED 41 is kept turned on only while the corresponding switch 31 is operated, it is difficult to recognize the light transmitted through the light-transmitting portion 40 if the switch 31 is operated only for a short time. In comparison with this, in the case where the LED 41 is kept turned on for a predetermined time after operation of the switches 31 is detected, the user can easily recognize the light transmitted through the light-transmitting portion 40, even if the switch 31 is operated only for a short time. Further, the LED may be configured to be kept turned on for a certain time after the operation is ended if the operating time of the switch 31 is short, and turned off when the operation is ended if the operation time of the switch 31 is long.

Further, although the user has checked recognition of operation of the switch by temporal lighting of the LED 41 corresponding to the switch 31, there are some switches in which it takes time to perform the function corresponding to the operation of the switch. In operation of such switches, it is difficult for the user to determine whether the function is actually operated or not. Examples of such switches are switches for starting a specific application, such as the TV switch 31a, the CD/DVD switch 31b, and the record switch 31g, the monitor input switch 31i which switches the display source of the LCD 16 to a source input from the outside, and the image output switch 31j which switches the image output destination. In the case of the switches 31a, 31b and 31g, it takes time to start the applications. Further, in the case of switches 31i and 31j, there is a time-lag between the operation of the switch and switching the image or source.

In the case of operating the above switches, the user may touch the switch 31 repeatedly since the user cannot easily recognize whether the function is performed or not by touching the switch 31 once. Thus, there are cases where it is difficult to perform the target function. Therefore, the LED 41 is preferably kept turned on while the function is performed after the switch 31 is operated, to indicate that the function is performed. Further, the LED 41 may be configured to blink. In the case of operating the image output switch, the term “performing the function” means that the image is being output to the outside.

Further, if the play/pause switch 31c is touched to suspend playback when the AV viewing application is playing back images/music, the LED 41 corresponding to the light-transmitting portion 40c is preferably configured to blink. Such a structure facilitates the user's recognition that the playback is suspended.

The computer may be provided with a vibrator that vibrates the panel 50, on which the switch 31 is disposed, together with lighting up of the LED 41 when the switch 31 is operated. The computer may be configured such that the speakers S_{R} and S_{L} sound together with lighting of the LED 41 when the switch 31 is operated. By the vibration or the sound, the user can check that the operation of the switch has been recognized by the computer, without viewing the light-transmitting portion 40.

Further, as shown in FIG. 7, an LED 41 may be mounted on a printed circuit board 53 separate from the printed circuit board 51 on which the electrode 32 of the switch 31 is printed. Although this structure increases the number of printed circuit boards, it eliminates the need for an optical guide, since the LED 41 can directly illuminate the light-transmitting portion 40. Since the optical guide becomes unnecessary, the light from the LED 41 reaches the light-transmitting portion 40 without being attenuated. As a result, this structure enables use of an LED 41 with a lower light-emitting power.

As described above, according to the embodiment, when the user operates the switch 31, the LED 41 provided inside the personal computer main body 12 is lit up, and the light is transmitted through the light-transmitting portion 40 provided in the back side of the switch 31. Thereby, the user can easily check that the operation of the switch 31 has been recognized by the computer. This structure prevents misoperation such as touching the switch 31 twice.

In the above embodiment, explained is the case where the switches and the light-transmitting portions are provided on the personal computers. The switches and the light-transmitting portions may be provided on displays and/or PDAs, etc. In displays and PDAs, the light-transmitting portions are provided in portions that are not covered with the user's fingers, and thereby the user can recognize the light transmitted through the light-transmitting portion when a switch is operated.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus comprising:
a housing having a surface;
a first capacitance switch positioned in a first region of the surface;
a first light-emitting element configure to emit light when the first capacitance switch operated; and
a first light-transmitting portion positioned in a second region of the surface and transmits the light from the first light-emitting element.

2. The electronic apparatus according to claim 1, wherein
the first region of the housing is formed of a dielectric, and
the first capacitance switch has an electrode which is positioned on an internal surface of the housing and opposed to the first region.

3. The electronic apparatus according to claim 1, wherein
the housing under the first region is formed of a dielectric,
the first capacitance switch has an electrode which is positioned on an internal surface of the housing and opposed to the first region, and
the electronic apparatus further comprises:
a substrate which is positioned opposite the internal surface of the housing, and has an upper surface provided with the electrode and an under surface provided with the first light-emitting element; and
an optical guide to guide the light emitted from the first light-emitting element to the first light-transmitting portion.

4. The electronic apparatus according to claim 3, wherein
the first light-emitting element emits light in a direction from the upper surface of the substrate to the under surface of the substrate.

5. The electronic apparatus according to claim 1, wherein
the first region of the housing is formed of a dielectric,
the first capacitance switch has an electrode which is positioned on an internal surface of the housing and opposed to the first region, and
the electronic apparatus further comprises:
a first substrate which is positioned opposite the internal surface of the housing, and has an upper surface provided with the electrode; and
a second substrate which is positioned inside the housing and provided with the first light-emitting element opposite the second region.

6. The electronic apparatus according to claim 1, further comprising:
a display portion which is supported by a support portion provided on an end portion of the housing, and rotatable between a closed position where the display portion covers the surface of the housing and an open position where the surface of the housing is exposed; and
a keyboard provided in the surface of the housing,
wherein the first region is located between the keyboard and the end portion, and
the second region is located between the first region and the end portion.

7. The electronic apparatus according to claim 1, further comprising:
a memory means which records information indicating a lighting operation of the first light-emitting element, the lighting operation being performed if the first capacitance switch is operated; and
a changing section to change the information recorded in the memory means.

8. The electronic apparatus according to claim 1, further comprising:
a second capacitance switch which is positioned in a third region of the surface;
a second light-emitting element which emits light if the second capacitance switch is operated;
a second light-transmitting portion which is positioned in a fourth region of the surface, and transmits the light from the second light-emitting element; and
a controller which drives, if the first capacitance switch or the second capacitance switch is operated, one of the first and the second light-emitting elements corresponding to the operated switch.

9. The electronic apparatus according to claim 8, wherein
the controller controls a lighting state of the light-emitting element corresponding to the operated switch, in accordance with a function to be performed in association with the operated capacitance switch if the first or the second capacitance switch is operated.

10. The electronic apparatus according to claim 9, wherein
a first function which is performed in response to operation of the first capacitance switch is kept performed after the operation of the first capacitance switch is completed, and
the controller causes the first light-emitting element to light up or blink while the first function is kept performed since the first capacitance switch is operated.
